(19) United States
(12) Patent Application Publication
(10) Pub. No.: US 2021/0074265 A1
(43) Pub. Date: Mar. 11, 2021

(54) VOICE SKILL CREATION METHOD, ELECTRONIC DEVICE AND MEDIUM

(71) Applicant: BAIDU ONLINE NETWORK TECHNOLOGY (BEIJING) CO., LTD., Beijing (CN)

(72) Inventor: Yaowen QI, Beijing (CN)

(21) Appl. No.: 16/871,502

(22) Filed: May 11, 2020

(30) Foreign Application Priority Data
Sep. 11, 2019 (CN) 201910859374.1

(51) Int. Cl. G10L 15/06; G06F 3/16; G10L 15/22; G06F 8/33

(52) U.S. Cl. CPC G10L 15/063; G06F 3/167; G06F 16/90332; G06F 8/33; G10L 2015/0638; G10L 15/22

(57) ABSTRACT

The present disclosure provides a voice skill creation method, an electronic device and a medium, and relates to a technical field of voice skills. A specific implementation of the present disclosure may be as follows. In response to a request for creating a voice skill, an editing interface is displayed, the editing interface at least including a plot configuration sub-interface. A plot interaction text configured by a user through the plot configuration sub-interface is obtained. Voice interaction information is generated based on the plot interaction text, and the voice skill is created according to the voice interaction information.

### CROSS-REFERENCE TO RELATED APPLICATION

This application claims priority to and benefits of Chinese Patent Application Serial No. 201910859374.1, filed the State Intellectual Property Office of P. R. China on Sep. 11, 2019, the entire content of which is incorporated herein by reference.

### TECHNICAL FIELD

The present disclosure relates to an internet technology field, particularly to a voice skill technology field, and more particularly, to a voice skill creation method and a voice skill creation device, an electronic device and a medium.

### BACKGROUND

With the development of artificial intelligence technology, smart devices such as smart speakers have become more and more popular, and are filled in people's daily lives. Voice skills, as basic functions of smart devices, can provide users with conversational interaction services, simulating the interaction scenarios in the users' real life. The skills are an extremely important branch that can realize interactive scenarios where a user can interact through his voices. The user can interact with the voice skill just by speaking, just as naturally as interact with human.

### SUMMARY

Embodiments of the present disclosure provide a voice skill creation method. The method includes: displaying an editing interface in response to a request for creating a voice skill, in which the editing interface at least includes a plot configuration sub-interface; obtaining a plot interaction text configured by a user through the plot configuration sub-interface; and generating voice interaction information based on the plot interaction text, and creating the voice skill according to the voice interaction information.

Embodiments of the present disclosure provide a voice skill creation device. The device includes: an editing interface display module, configured to display an editing interface in response to a request for creating a voice skill, wherein the editing interface at least comprises a plot configuration sub-interface; a plot obtaining module, configured to obtain a plot interaction text configured by a user through the plot configuration sub-interface; and a skill creating module, configured to generate voice interaction information based on the plot interaction text, and to create the voice skill according to the voice interaction information.

Embodiments of the present disclosure provide an electronic device, the electronic device includes: at least one processor; and a memory coupled in communication with the at least one processor; in which, the memory stores instructions executable by the at least one processor, when the instructions are executed by the at least one processor, the at least one processor are caused to implement the voice skill creation method according to any embodiment of the present disclosure.

Embodiments of the present disclosure provide a non-transitory computer-readable storage medium having computer instructions stored thereon, in which the computer instructions are configured to cause the computer to implement the voice skill creation method according to any embodiment of the present disclosure.

Additional effects of the foregoing optional manners will be described below with reference to specific embodiments.

### BRIEF DESCRIPTION OF THE DRAWINGS

The drawings are used to better understand the present disclosure, and do not constitute a limitation on the present disclosure, in which:

FIG. 1 is a flowchart of a voice skill creation method according to an embodiment of the present disclosure.

FIG. 2 is a schematic diagram illustrating an effect of a plot configuration sub-interface of a configured plot according to an embodiment of the disclosure.

FIG. 3 is a schematic diagram illustrating an effect of an editing interface according to an embodiment of the present disclosure.

FIG. 4 is a flowchart of a voice skill creation method according to another embodiment of the present disclosure.

FIG. 5 is a block diagram of a voice skill creation device according to an embodiment of the present disclosure.

FIG. 6 is a block diagram of an electronic device used to implement the voice skill creation method according to the embodiment of the present disclosure.

### DETAILED DESCRIPTION

Explanatory embodiments of the present disclosure will be described with reference to the accompany drawings, which include various details of the embodiments of the present disclosure to facilitate understanding, and should be considered as merely exemplary. Therefore, those skilled in the art should recognize that, various changes and modifications can be made to the embodiments described herein without departing from the scope and spirit of the present disclosure. Also, for clarity and conciseness, descriptions of well-known functions and structures are omitted in the following description.

With the development of artificial intelligence technology, smart devices such as smart speakers have become more and more popular, and are filled in people's daily lives. Voice skills, as basic functions of smart devices, can provide users with conversational interaction services, simulating the interaction scenarios in the users' real life. The skills are an extremely important branch that can realize interactive scenarios where a user can interact through his voices. The user can interact with the voice skill just by speaking, just as naturally as interact with human.

At present, voice skills can only be created by professional developers by writing codes. For users who do not have professional development capabilities, they cannot create and maintain voice skills. Therefore, the efficiency of creating and maintaining the voice skill is low.

Therefore, embodiments of the present disclosure provide a voice skill creation method, a voice skill creation device, an electronic device, and a non-transitory computer-readable storage medium.

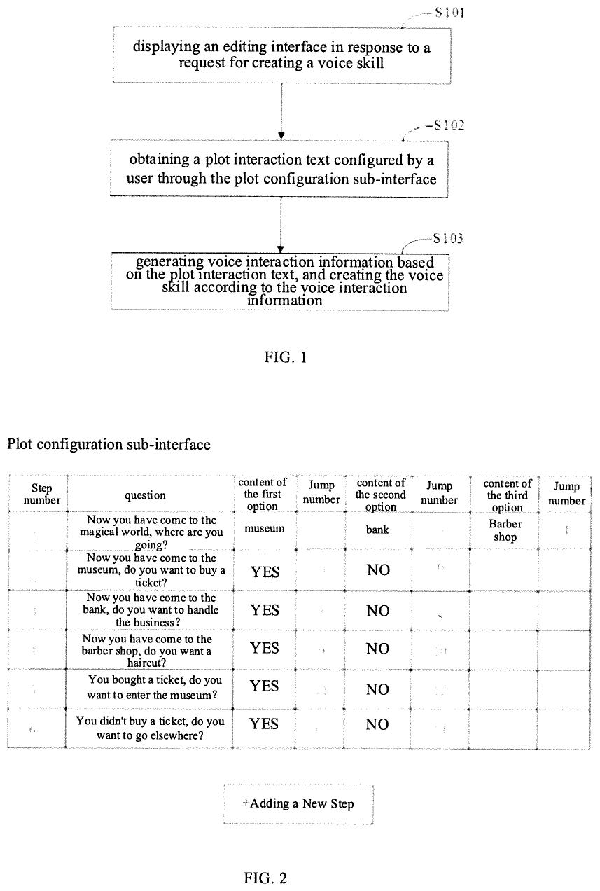

FIG. 1 is a flowchart of a voice skill creation method according to an embodiment of the present disclosure. This embodiment is applicable for a case of developing a voice skill for a smart device with voice recognition capabilities, such as developing a story-type voice skill for the smart device. The method may be executed by a voice skill creation device, which is implemented in software and/or hardware, and is preferably configured in an electronic device, such as a smart device like a smart speaker, or in a server for creating a voice skill for smart devices. As illustrated in FIG. 1, the method includes the following actions.

At block S101, in response to a request for creating a voice skill, an editing interface is displayed.

The editing interface at least includes a plot configuration sub-interface. The plot configuration sub-interface is configured to configure respective steps in the plot, respective question involved in each step, different option contents involved in respective questions, and jump step numbers of the different option contents.

The plot configuration sub-interface provides an “Adding a New Step” control. Users can click this control to add a new step, meanwhile, can edit respective questions involved in the new step in the plot, different option contents involved in the respective questions, and jump step numbers of the different option contents. It is noted that the user can write directly through text input instead of writing code to ensure that non-professionals can also use the plot configuration sub-interface to write the plot simply and quickly. For example, FIG. 2 is a schematic diagram of a plot configuration sub-interface of a configured plot according to an embodiment of the disclosure.

At block S102, a plot interaction text configured by a user through the plot configuration sub-interface is obtained.

For example, as illustrated in FIG. 2, by taking the creation of a story-type voice skill as an example, a story plot is added in the plot configuration sub-interface. After the user completes editing a plot, the system can obtain all steps of the plot, the respective questions involved in each step, the different option contents involved in each question and the jump step numbers of different option contents, and the obtained data contents are used as the plot interaction text.

At block S103, voice interaction information is generated based on the plot interaction text, and the voice skill is created according to the voice interaction information.

Optionally, the voice skill can be created by the following actions.

At action S1, the voice interaction information is generated based on each question involved in each step in the plot and the different option contents involved in each question.

In an embodiment, the voice interaction information may be a voice dialogue strategy. For example, for the content corresponding to step 1 in FIG. 2, the voice interaction information is generated as “Now you have come to the magical world, where are you going? The first one is the museum; the second one is the bank; and the third one is the barbershop. Your choice can be the first one, the second one, or the third one”.

At action S2, the voice skill is created based on the voice interaction information, each step in the plot and the jump step numbers of the different option contents.

The voice interaction information of different steps are combined according to the respective steps in the plot and the jump step numbers of different option contents, to generate the voice skill. For example, according to the plot in FIG. 2, a story-type voice skill is generated. A smart device can complete voice interactions with a user based on the voice skill subsequently. In detail, the smart device according to the present disclosure may further include a voice recognition module, which is configured to recognize the user's voice. Jumps between the respective steps in the plot is performed according to a recognition result to complete the voice interaction. For example, the voice interaction process may be as follows.

The smart device says “Now you have come to the magical world, where are you going? The first one is the museum; the second one is the bank; and the third one is the barbershop. Your choice can be the first, the second, or the third”.

The use says “The first one”.

The smart device says “Now you have come to the museum, do you want to buy a ticket? The first, yes; and the second, no”.

With the technical solution of the present disclosure, by providing the editing interface for the user to configure the plot, and the voice interaction information is generated based on the plot configured by the user, and then the voice skill is created based on the voice interaction information, thus the users without professional development capabilities is enable to create the voice skill for a smart device, improving efficiency of creating and maintaining the voice skill.

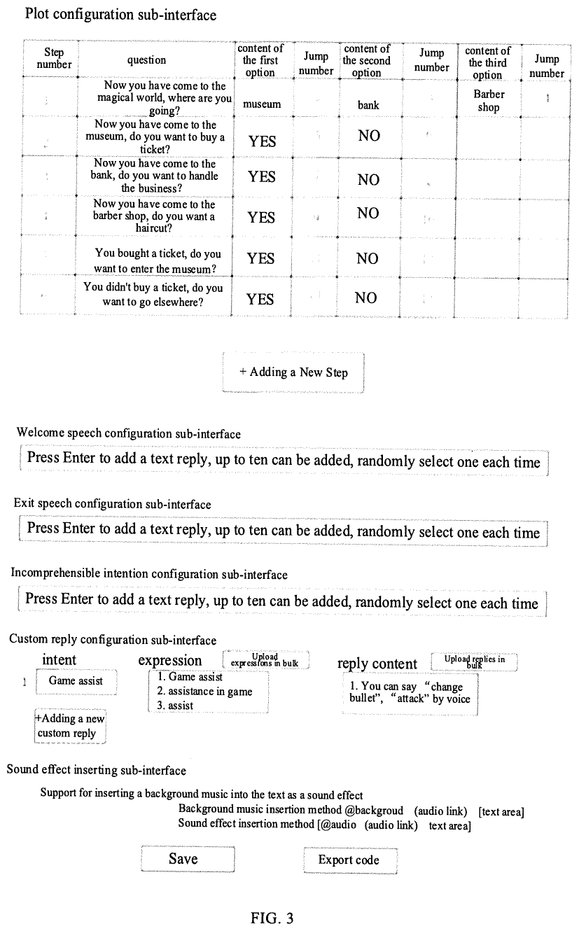

FIG. 3 is a schematic diagram of an editing interface according to an embodiment of the present disclosure. The editing interface further provides a welcome speech configuration sub-interface, an exit speech configuration sub-interface, an incomprehensible intent configuration sub-interface, a custom reply configuration sub-interface, and a sound effect inserting sub-interface in addition to the above plot configuration sub-interface.

The welcome speech configuration sub-interface is configured to configure a welcome speech broadcasted when the voice skill is entered, as a guide to the entire skill. It is noted that there may be a plurality of welcome speeches, and one speech may be randomly selected from the plurality of welcome speeches for broadcast.

The exit speech configuration sub-interface is configured to configure an exit speech broadcasted when the voice skill exits. Similarly, it is noted that there may be a plurality of exit speeches, one speech may be randomly selected from the plurality of exit speeches for broadcast.

The incomprehensible intent configuration sub-interface is configured to configure a guide speech, and the guide speech is configured to be broadcasted to prompt and guide the user to interact with a set instruction in the plot when a voice recognition result of the user misses a voice interaction scene setting of the plot in the voice skill. It is noted that there may be a plurality of guide speeches, one speech may be randomly selected from the plurality of guide speeches for broadcast.

The custom reply configuration sub-interface is configured to configure a custom reply content, in which the custom reply content at least includes an intent, an expression and a reply content, and the custom reply configuration sub-interface is further configured to broadcast the replay content when a voice recognition result of the current expression of the user hits the intent, which helps the user to perform the interaction.

The sound effect inserting sub-interface is configured to configure a sound effect to be broadcast at any position in the plot. The sound effect can be pseudo-code audio of a standard format specification and links added by the user. The pseudo-code audio can be directly inserted into the text, and the smart device may broadcast the audio according to the insertion of the user.

In the solution of the embodiment of the present disclosure, the editing interface may be an interface of an editor, and the voice skill can be created through a visual and convenient operation of the editor. The editing interface also provides the welcome speech configuration sub-interface, the exit speech configuration sub-interface, the incomprehensible intent configuration sub-interface, the custom reply configuration sub-interface, and the corresponding configurations can guide or help the user to conduct voice interactions, thereby improving the voice interaction experience. The pseudo-code audio insertion may be supported through the sound effect configuration sub-interface, thus improving the richness of the voice skill.

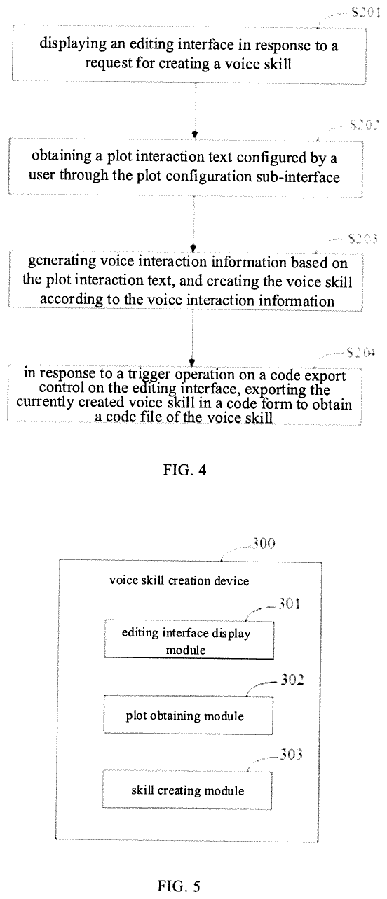

FIG. 4 is a flowchart of a voice skill creation method according to another embodiment of the present disclosure. This embodiment is further optimized on the basis of the foregoing embodiment, and a code exporting step is added. As illustrated in FIG. 4, the method includes the following actions.

At block S201, in response to a request for creating a voice skill, an editing interface is displayed.

The editing interface includes at least one of a plot configuration sub-interface, a welcome speech configuration sub-interface, an exit speech configuration sub-interface, an incomprehensible intent configuration sub-interface, a custom reply configuration sub-interface, a sound effect inserting sub-interface, a sound effect inserting sub-interface, and a code export control.

At block S202, a plot interaction text configured by a user through the plot configuration sub-interface is obtained.

At block S203, voice interaction information is generated based on the plot interaction text, and the voice skill is created according to the voice interaction information.

At block S204, in response to a trigger operation on a code export control on the editing interface, the currently created voice skill is exported in a code form to obtain a code file of the voice skill.

The triggering operation may be a single-click operation or a double-click operation.

In the embodiment of the present disclosure, by exporting the currently created voice skill in the code form in response to the trigger operation of the user, it is convenient for the user to edit the code for second time, thereby making the skill more abundant.

FIG. 5 is a schematic diagram of a voice skill creation device according to an embodiment of the present disclosure, which is applicable for a case of developing a voice skill for a device having a voice interaction function. The device can implement the voice skill creation method described in any embodiment of the present disclosure. As illustrated in FIG. 5, the device 300 specifically includes an editing interface display module 301, a plot obtaining module 302, and a skill creating module 303.

The editing interface display module 301 is configured to display an editing interface in response to a request for creating a voice skill, in which the editing interface at least includes a plot configuration sub-interface.

The plot obtaining module 302 is configured to obtain a plot interaction text configured by a user through the plot configuration sub-interface.

The skill creating module 303 is configured to generate voice interaction information based on the plot interaction text, and to create the voice skill according to the voice interaction information.

Optionally, the plot configuration sub-interface is configured to configure each step in a plot, each question involved in each step, different option contents involved in each question, and jump step numbers of the different option contents.

Optionally, the skill creating module includes an interaction information generation unit and a skill creating unit.

The interaction information generation unit is configured to generate the voice interaction information based on each question involved in each step in the plot and the different option contents involved in each question.

The skill creating unit is configured to create the voice skill based on the voice interaction information, each step in the plot and the jump step numbers of the different option contents.

Optionally, the editing interface further includes a welcome speech configuration sub-interface configured to configure a welcome speech broadcasted when the voice skill is entered.

Optionally, the editing interface further includes an exit speech configuration sub-interface configured to configure an exit speech broadcasted when the voice skill exits.

Optionally, the editing interface further includes an incomprehensible intent configuration sub-interface configured to configure a guide speech, and the guide speech is configured to be broadcasted to prompt and guide the user to interact with a set instruction in the plot when a voice recognition result of the user misses a voice interaction scene setting of the plot in the voice skill.

Optionally, the editing interface further includes a custom reply configuration sub-interface configured to configure a custom reply content, in which the custom reply content at least comprises an intent, an expression and a reply content, and the custom reply configuration sub-interface is further configured to broadcast the replay content when a voice recognition result of the current expression of the user hits the intent.

Optionally, the editing interface further includes a sound effect inserting sub-interface configured to configure a sound effect to be broadcast at any position in the plot.

Optionally, the device further includes: a code file generation module, configured to export the currently created voice skill in a code form to obtain a code file of the voice skill in response to a trigger operation on a code export control on the editing interface.

The voice skill creation device in the embodiment of the present disclosure can execute the voice skill creation method in any embodiment of the present disclosure, and has the corresponding functional modules and beneficial effects of the executed method. For content that is not described in detail in this embodiment, reference may be made to the description in any method embodiment of the present disclosure.

According to an embodiment of the present disclosure, the present disclosure further provides an electronic device and a readable storage medium.

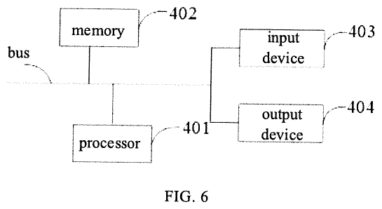

FIG. 6 is a block diagram of an electronic device used to implement the voice skill creation method according to the embodiment of the present disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital assistant, cellular phones, smart phones, wearable devices, and other similar computing devices. The components shown here, their connections and relations, and their functions are merely examples, and are not intended to limit the implementation of the disclosure described and/or required herein.

As illustrated in FIG. 6, the electronic device includes: one or more processors 401, a memory 402, and interfaces for connecting various components, including a high-speed interface and a low-speed interface. The various components are interconnected using different buses and can be mounted on a public mainboard or otherwise installed as required. The processor may process instructions executed within the electronic device, including instructions stored in or on the memory to display graphical information of the GUI on an external input/output device such as a display device coupled to the interface. In other implementations, a plurality of processors and/or buses can be used with a plurality of memories and processors, if desired. Similarly, a plurality of electronic devices can be connected, each providing some of the necessary operations, for example, implemented as a server array, a group of blade servers, or a multiprocessor system. A processor 401 is taken as an example in FIG. 6.

The memory 402 is the non-transitory computer-readable storage medium according to the present disclosure. The memory stores instructions executable by at least one processor, so that the at least one processor executes the voice skill creation method according to the present disclosure. The non-transitory computer-readable storage medium of the present disclosure stores computer instructions, which are used to cause a computer to execute the voice skill creation method according to the present disclosure.

As a non-transitory computer-readable storage medium, the memory 402 is configured to store non-transitory software programs, non-transitory computer executable programs and modules, such as program instructions/modules corresponding to the voice skill creation method in the embodiment of the present disclosure, such as the editing interface display module 301, the plot obtaining module 302, and the skill creating module 303 shown in FIG. 5. The processor 401 executes various functional applications and data processing of the server by running non-transitory software programs, instructions, and modules stored in the memory 402, that is, implementing the voice skill creation method in the foregoing method embodiment.

The memory 402 may include a program storage area and a data storage area, where the program storage area may store an operating system and applications required for at least one function. The data storage area may store data created according to the use of the electronic device implementing the voice skill creation method, and the like. In addition, the memory 402 may include a high-speed random access memory, and a non-transitory memory, such as at least one magnetic disk storage device, a flash memory device, or other non-transitory solid-state storage device. In some embodiments, the memory 402 may optionally include a memory remotely disposed with respect to the processor 401, and these remote memories may be connected to the electronic device through a network. Examples of the above network include, but are not limited to, the Internet, an intranet, a local area network, a mobile communication network, and combinations thereof.

The electronic device implementing the voice skill creation method may further include an input device 403 and an output device 404. The processor 401, the memory 402, the input device 403, and the output device 404 may be connected through a bus or in other manners. In FIG. 6, the connection through the bus is taken as an example.

The input device 403 may receive inputted numeric or character information, and generate key signal inputs related to user settings and function control of the electronic device implementing the voice skill creation method, such as a touch screen, a keypad, a mouse, a trackpad, a touchpad, an indication rod, one or more mouse buttons, trackballs, joysticks and other input devices. The output device 904 may include a display device, an auxiliary lighting device (for example, an LED), a haptic feedback device (for example, a vibration motor), and the like. The display device may include, but is not limited to, a liquid crystal display (LCD), a light emitting diode (LED) display, and a plasma display. In some embodiments, the display device may be a touch screen.

Various implementations of the systems and technologies described herein may be implemented in digital electronic circuit systems, integrated circuit systems, application specific integrated circuits (ASICs), computer hardware, firmware, software, and/or combinations thereof. These various implementations may be implemented in one or more computer programs, which may be executed and/or interpreted on a programmable system including at least one programmable processor. The programmable processor may be dedicated or general purpose programmable processor that may receive data and instructions from a storage system, at least one input device, and at least one output device, and may transmit the data and instructions to the storage system, the at least one input device, and the at least one output device.

These computing programs (also known as programs, software, software applications, or code) include machine instructions of a programmable processor, and these computing programs may be implemented by utilizing high-level processes and/or object-oriented programming languages, and/or assembly/machine languages. As used herein, the terms “machine-readable medium” and “computer-readable medium” refer to any computer program product, device, and/or device used to provide machine instructions and/or data to a programmable processor (for example, magnetic disks, optical disks, memories, programmable logic devices (PLDs), including machine-readable media that receive machine instructions as machine-readable signals. The term “machine-readable signal” refers to any signal used to provide machine instructions and/or data to a programmable processor.

In order to provide interaction with a user, the systems and techniques described herein may be implemented on a computer having a display device (e.g., a Cathode Ray Tube (CRT) or a Liquid Crystal Display (LCD) monitor) for displaying information to a user, and a keyboard and a pointing device (such as a mouse or a trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or a computing system that includes any combination of such background components, middleware components, or front-end components. The components of the system may be interconnected through digital data communication (e.g., a communication network) of any form or medium. Examples of the communication network include local area network (LAN), wide area network (WAN), and the Internet.

The computer system may include a client and a server. The client and server are generally remote from each other and interact with each other through a communication network. The client-server relation is generated by computer programs running on the corresponding computers and having a client-server relation with each other.

With the embodiment of the disclosure, by providing the editing interface for the user to configure the plot, and the voice interaction information is generated based on the plot configured by the user, and then the voice skill is created based on the voice interaction information, thus the users without professional development capabilities is enable to create the voice skill for a smart device, improving efficiency of creating and maintaining the voice skill. In addition, the editing interface provides the welcome speech configuration sub-interface, the exit speech configuration sub-interface, the incomprehensible intent configuration sub-interface, and the custom reply configuration sub-interface, and the corresponding configurations can guide or help the user to conduct voice interaction, thereby improving voice interaction experience. Meanwhile, by exporting the currently created voice skill in the code form, it is convenient for the user to edit the code for second time, thereby making the skill more abundant.

It should be understood that the various forms of processes shown above can be used to reorder, add, or delete steps. For example, the steps described in the present disclosure can be executed in parallel, sequentially, or in different orders, as long as the desired results of the technical solutions disclosed in the present disclosure can be achieved, which is not limited herein.

The foregoing specific implementations do not constitute a limitation on the protection scope of the present disclosure. It should be understood by those skilled in the art that various modifications, combinations, sub-combinations, and substitutions may be made according to design requirements and other factors. Any modification, equivalent replacement and improvement made within the spirit and principle of the present disclosure shall be included in the protection scope of the present disclosure.

What is claimed is:

1. A voice skill creation method, comprising:
displaying an editing interface in response to a request for creating a voice skill, wherein the editing interface at least comprises a plot configuration sub-interface;
obtaining a plot interaction text configured by a user through the plot configuration sub-interface; and
generating voice interaction information based on the plot interaction text, and creating the voice skill according to the voice interaction information.

2. The method according to claim 1, wherein the plot configuration sub-interface is configured to configure each step in a plot, each question involved in each step, different option contents involved in each question, and jump step numbers of the different option contents.

3. The method according to claim 2, wherein generating the voice interaction information based on the plot interaction text and creating the voice skill according to the voice interaction information comprises:
generating the voice interaction information based on each question involved in each step in the plot and the different option contents involved in each question; and
creating the voice skill based on the voice interaction information, each step in the plot and the jump step numbers of the different option contents.

4. The method according to claim 1, wherein the editing interface comprises a welcome speech configuration sub-interface configured to configure a welcome speech broadcasted when the voice skill is entered.

5. The method according to claim 1, wherein the editing interface comprises an exit speech configuration sub-interface configured to configure an exit speech broadcasted when the voice skill exits.

6. The method according to claim 1, wherein the editing interface comprises an incomprehensible intent configuration sub-interface configured to configure a guide speech, and the guide speech is configured to be broadcasted to prompt and guide the user to interact with a set instruction in the plot when a voice recognition result of the user misses a voice interaction scene setting of the plot in the voice skill.

7. The method according to claim 1, wherein the editing interface comprises a custom reply configuration sub-interface configured to configure a custom reply content, wherein the custom reply content at least comprises an intent, an expression and a reply content, and the custom reply configuration sub-interface is further configured to broadcast the replay content when a voice recognition result of the current expression of the user hits the intent.

8. The method according to claim 1, wherein the editing interface comprises a sound effect inserting sub-interface configured to configure a sound effect to be broadcast at any position in the plot.

9. The method according to claim 1, further comprising:
in response to a trigger operation on a code export control on the editing interface, exporting the currently created voice skill in a code form to obtain a code file of the voice skill.

10. An electronic device, comprising:
at least one processor; and
a memory coupled in communication with the at least one processor; wherein,
the memory stores instructions executable by the at least one processor, when the instructions are executed by the at least one processor, the at least one processor are caused to implement a voice skill creation method, the method comprising:
displaying an editing interface in response to a request for creating a voice skill, wherein the editing interface at least comprises a plot configuration sub-interface;
obtaining a plot interaction text configured by a user through the plot configuration sub-interface; and
generating voice interaction information based on the plot interaction text, and creating the voice skill according to the voice interaction information.

11. The electronic device according to claim 10, wherein the plot configuration sub-interface is configured to configure each step in a plot, each question involved in each step, different option contents involved in each question, and jump step numbers of the different option contents.

12. The electronic device according to claim 11, wherein generating the voice interaction information based on the plot interaction text and creating the voice skill according to the voice interaction information comprises:
generating the voice interaction information based on each question involved in each step in the plot and the different option contents involved in each question; and
creating the voice skill based on the voice interaction information, each step in the plot and the jump step numbers of the different option contents.

13. The electronic device according to claim 10, wherein the editing interface comprises a welcome speech configuration sub-interface configured to configure a welcome speech broadcasted when the voice skill is entered.

14. The electronic device according to claim 10, wherein the editing interface comprises an exit speech configuration sub-interface configured to configure an exit speech broadcasted when the voice skill exits.

15. The electronic device according to claim 10, wherein the editing interface comprises an incomprehensible intent configuration sub-interface configured to configure a guide speech, and the guide speech is configured to be broadcasted to prompt and guide the user to interact with a set instruction in the plot when a voice recognition result of the user misses a voice interaction scene setting of the plot in the voice skill.

16. The electronic device according to claim 10, wherein the editing interface comprises a custom reply configuration sub-interface configured to configure a custom reply content, wherein the custom reply content at least comprises an intent, an expression and a reply content, and the custom reply configuration sub-interface is further configured to broadcast the replay content when a voice recognition result of the current expression of the user hits the intent.

17. The electronic device according to claim 10, wherein the editing interface comprises a sound effect inserting sub-interface configured to configure a sound effect to be broadcast at any position in the plot.

18. The electronic device according to claim 10, further comprising:
in response to a trigger operation on a code export control on the editing interface, exporting the currently created voice skill in a code form to obtain a code file of the voice skill.

19. A non-transitory computer-readable storage medium having computer instructions stored thereon, wherein the computer instructions are configured to cause the computer to implement a voice skill creation method, the method comprising:
displaying an editing interface in response to a request for creating a voice skill, wherein the editing interface at least comprises a plot configuration sub-interface;
obtaining a plot interaction text configured by a user through the plot configuration sub-interface; and
generating voice interaction information based on the plot interaction text, and creating the voice skill according to the voice interaction information.

20. The storage medium according to claim 19, wherein the method further comprises:
in response to a trigger operation on a code export control on the editing interface, exporting the currently created voice skill in a code form to obtain a code file of the voice skill.
